(19) United States
(12) Patent Application Publication
(10) Pub. No.: US 2010/0157394 A1
(43) Pub. Date: Jun. 24, 2010

(54) THERMAL DYE ELEMENTS USEFUL FOR COLOR PROOFING

(76) Inventors: Kevin M. Kidnie, St. Paul, MN (US); Pao Vang, Brooklyn Park, MN (US); Linda A. Kaszczuk, Webster, NY (US)

Correspondence Address: Raymond L. Owens;Patent Legal Staff, Eastman Kodak Company, 343 State Street, Rochester, NY, 14650-2201, US

(21) Appl. No.: 12/406,147

(22) Filed: Mar. 18, 2009

Related U.S. Application Data
(60) Provisional application No. 61/139,118, filed on Dec. 19, 2008.

(51) Int. Cl. H04N 1/46; B41M 5/40

(52) U.S. Cl. 358/500; 428/32.39; 428/32.6; 428/32.52

(57) ABSTRACT

A thermal element has a support and either a thermal donor layer or a thermal dye receiving layer. The thermal element also includes a spirobiindane in an amount of at least 20 mg/m² that provides improved dye image stability. These thermal dye elements can be used for color proofing.

### CROSS-REFERENCE TO RELATED APPLICATIONS

Reference is made to and priority claimed from U.S. Provisional Application Ser. No. 61/139,118, filed Dec. 19, 2008, entitled THERMAL DYE ELEMENTS USEFUL FOR COLOR PROOFING.

### FIELD OF THE INVENTION

This invention relates to thermal elements that can be used as either thermal donor elements or thermal dye receiver elements in a process of making proofs for color printed images. This invention also relates to a method of making a color proof using one or both of these thermal elements.

### BACKGROUND OF THE INVENTION

In order to approximate the appearance of a continuous-tone printed image, the commercial printing industry relies on a process known as halftone printing. In halftone printing, color density gradations are produced by printing patterns of dots or area of varying sizes, but of the same color density, instead of varying the color density continuously as is done in photographic printing.

There is an important commercial need to obtain a color proof image before a printing press run is made. It is desired that the color proof will accurately represent at least the details and the color tone scale of the prints that will be obtained on the printing press. In many cases, it is also important that the color proof accurately represent the image quality and halftone pattern of the prints to be obtained on the printing press. In the sequence of operations necessary to produce an ink-printed, full-color picture, a color proof is also needed to check the accuracy of the color separation data from which the final three or more printing plates or cylinders are made. Traditionally, such color separation proofs have involved silver halide photographic, high-contrast lithographic systems or non-silver halide light-sensitive systems that require many exposure and processing steps before a final, full-color picture is assembled.

In the printing industry, the usual process colors are cyan, magenta, yellow, and black although is it sometimes desired to use inks containing pigments that provide colors that are outside the usual process. See for example, the use of mixtures of dyes to provide green color proofing elements in U.S. Pat. No. 6,162,761 (Chapman et al.).

A number of commercial color proofing elements are known including those marketed under the name Approval® by Eastman Kodak Company (Rochester, N.Y.).

### SUMMARY OF THE INVENTION

This invention provides a thermal element comprising a support and having disposed thereon either a thermal donor layer or a thermal dye receiving layer, the thermal dye element further comprising a spirobiindane in an amount of at least 20 mg/m².

This invention also provides a thermal dye transfer assemblage comprising:

a) a thermal donor element, and

b) a thermal dye receiving element, the thermal dye receiving element being in superposed relationship with the thermal donor element so that the donor layer of the thermal donor element is in contact with the thermal dye image receiving layer of the thermal dye receiving element,

wherein the thermal donor element or the thermal dye receiving element, or both, comprises a spirobiindane in an amount of at least 20 mg/m².

Further, this invention provides a method of making color proof of a color printed image comprising:

A) generating digital signals representative of at least a portion of a color printed image,

B) contacting a thermal donor element comprising a support having thereon a thermal donor layer with a first thermal dye receiving element comprising a support having thereon a thermal dye receiving layer,

C) using the digital signals to transfer a dye image representative of the portion of the color printed image, from the thermal donor element to the first thermal dye receiving element, and

D) transferring the dye image from the first thermal intermediate dye receiving element to a second thermal final dye receiving element,

wherein either the thermal donor layer or the first thermal dye receiving layer, or both, comprises a spirobiindane in an amount of at least 20 mg/m².

Applicants have found a need for color proofing elements to have improved image stability, or reduced fading of the images in light. This need is met using the thermal elements of this invention. These elements include both thermal donors and thermal dye receiving elements (may also be known in the art as “intermediates” or “thermal intermediates”). The improvement is achieved by putting a spirobiindane in the thermal dye donor or dye image receiving layer of the thermal element.

### BRIEF DESCRIPTION OF THE DRAWINGS

FIG. 1 is a graphical representation of data obtained in Example 1 below.

FIG. 2 is a graphical representation of data obtained in Example 2 below.

FIG. 3 is a graphical representation of data obtained in Example 3 below.

FIG. 4 is a graphical representation of data obtained in Example 4 below.

FIG. 5 is a graphical representation of data obtained in Example 5 below.

### DETAILED DESCRIPTION OF THE INVENTION

The spirobiindanes useful in the practice of this invention have been found to stabilize the dye image obtained for color proofing elements. These compounds can be used singly or in combination. Moreover, they can be used in a single or multiple layers of the thermal elements. In general, these compounds have at least one and typically two or more, substituents that are attached to the aromatic rings through an oxy linkage, and in many embodiments, such substituents are alkoxy, cycloalkoxy, or aryloxy groups.

In most embodiments, the spirobiindanes can be represented by the following Structure (SP):

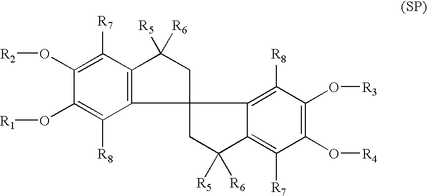

wherein R₁ through R₄ are independently substituted or unsubstituted alkyl, substituted or unsubstituted cycloalkyl, substituted or unsubstituted aryl substituted or unsubstituted heterocyclyl, halo, —COOR₈, or —CONR₉R₁₀ groups, and R₅ through R₈ are independently substituted or unsubstituted hydrogen or alkyl cycloalkyl, aryl, or halo groups, R₈ is a substituted or unsubstituted alkyl group, and R₉ and R₁₀ are independently hydrogen or a substituted or unsubstituted alkyl group. The noted alkyl groups can have 1 to 10 carbon atoms and be substituted with any substituent that would be readily apparent to one skilled in the art. The noted cycloalkyl groups can have 5 to 10 carbon atoms in the ring and have any suitable substituent that would be readily apparent to one skilled in the art. The noted aryl groups can have 6 or 10 carbon atoms in the aromatic ring and have any suitable substituent that would be readily apparent to one skilled in the art. The noted heterocyclyl groups can have 5 to 10 carbon and heteroatoms in the ring and have any suitable substituent that would be readily apparent to one skilled in the art.

In some embodiments, R₁ through R₈ are independently substituted or unsubstituted alkyl groups. In still other embodiments, R₁ through R₄ are the same substituted or unsubstituted alkyl groups and R₅ through R₈ are the same substituted or unsubstituted alkyl groups that are different from those of R₁ through R₄.

For example, some useful spirobiindanes include but are not limited to 3,3,3′,3′-tetramethyl-5,5′,6,6′-tetrapropoxy-1,1′-spirobiindane, 3,3,3′3′-tetramethyl-5,5′,6,6′-tetraethoxy-1,1′-spirobiindane, and 3,3,3′,3′-tetramethyl-5,5′6,6′-tetrabutoxy-1,1′-spirobiindane.

The one or more spirobiindanes are present in an amount of at least 20 mg/m² and typically from about 50 to about 500 mg/m². The optimum amount may vary depending upon the type of thermal element used.

In some embodiments, the thermal element is a thermal donor element, such as a thermal dye donor element from which one or more dyes or pigments may be transferred during imaging. Alternatively, the thermal donor element may have no dyes or pigments but still comprise a spirobiindane.

Generally, the thermal donor elements include a thermal donor layer (such as a thermal dye donor layer) disposed on a suitable substrate. Useful substrates include but are not limited to any material that can withstand the heat of a laser or thermal head including polyesters such as poly(ethylene terephthalate), polyamides, polycarbonates, cellulose esters such as cellulose acetate, fluorine polymers such poly(vinylidene fluoride) or poly(tetrafluoroethylene-co-hexafluoropropylene), polyethers such as polyoxymethylene, polyacetals, polyolefins such as polystyrene, polyethylene, polypropylene, or methylpentene polymers, and polyimides such as polyimide-amides and polyetherimides. The support may have a thickness of at least 50 μm and may be coated with a subbing layer if desired.

The reverse side of the support may be coated with a slipping layer to prevent the printing head from sticking to the thermal dye donor element. Such slipping layers typically include one or more solid or liquid lubricates, with or without a polymeric binder or surfactant. Particularly useful components and amounts for slipping layers are described in Col. 7 (lines 1-20) of U.S. Pat. No. 6,162,761 (noted above).

The thermal dye donor layer composition containing suitable thermally transferable dyes or pigments, polymeric binders, and spirobiindanes can be applied to support by coating or printing according to known procedures and conditions.

The thermal donor layer can comprise one or more thermally transferable dyes or pigments in one or more suitable polymeric binders. Useful polymeric binders include but are not limited to, cellulose derivatives such as cellulose acetate hydrogen phthalate, cellulose acetate, cellulose acetate propionate, cellulose acetate butyrate, cellulose triacetate, or any of the materials described in U.S. Pat. No. 4,700,207 (Vanier et al.), polycarbonates, poly(vinyl acetate), poly(styrene-co-acrylonitrile), polysulfones, and poly(phenylene oxide). The polymeric binder may be present in the thermal dye donor layer in an amount of from about 100 to about 5000 mg/m².

Useful thermally transferable dyes or pigments are known from a number of publications including but not limited to U.S. Pat. No. 5,126,760 (DeBoer), U.S. Pat. No. 5,177,062 (Ambro et al.), and U.S. Pat. No. 6,162,761 (Chapman et al.). Such dyes or pigments can be used singly or in mixtures to provide various color images including cyan, magenta, yellow, green, red, and orange. Carbon black and other black pigments can also be transferred to provide a black image. Useful amounts of thermally transferable dyes or pigments are at least 20 and up to and including 1000 mg/m².

In other embodiments, the thermal element is a thermal dye receiving element (or “intermediate” element) having a dye-receiving layer on a suitable support. Such substrates can be a transparent film such as poly(vinyl sulfone), a polyimide, a cellulose ester such as cellulose acetate, a poly(vinyl alcohol-co-acetal), or a polyester such as poly(ethylene terephthalate) or poly(ethylene naphthalate). However, the support may also be reflective such as baryta-coated paper, polyethylene-coated paper, an ivory paper, a condenser paper, or a synthetic paper. Pigmented supports such as white polyesters can also be used.

The dye-receiving layer can be composed of a spirobiindane as described above dispersed in a suitable binder including but are not limited to, a polycarbonate, polyester, poly(vinyl chloride), poly(styrene-co-acrylonitrile), polycaprolactone, poly(vinyl acetal) such as a poly(vinyl butyral) or poly(vinyl alcohol-co-acetal), or mixtures thereof.

As noted above, the thermal donor elements of this invention can be used to form a dye transfer image. Such a process comprises imagewise-heating a thermal dye donor element as described herein and transferring a dye image to a thermal dye receiving element to form a dye transfer image.

The thermal donor elements may be used in sheet form or in a continuous roll or ribbon. If a continuous roll or ribbon is employed, it may have only one dye or it may have alternating areas of different dyes or combinations of dyes. Thus, one-, two-, three-, or four-color elements (or higher numbers) are included within the scope of this invention.

Thermal printing heads that can be used to transfer dye from the thermal dye donor elements to thermal dye receiving elements are available commercially and include for example, a thermal print head.

In addition, a laser can also be used to transfer a dye and when a laser is used, it can be a diode laser that offers several advantages. If a laser is used, the thermal donor element usually contains a thermal absorbing material such as an infrared radiation absorbing pigment or dye, many of which are known in the art. Lasers that can be used in the manner are well known in the art. A thermal printer that uses such a laser to form a print image is described for example in U.S. Pat. No. 5,268,708 (Harshbarger et al.).

Spacer beads can be used in a separate layer over the dye layer of a thermal dye donor element to increase the uniformity and density of the transferred image. Alternatively, the spacer beads can be incorporated into the thermal dye receiving layer of a thermal dye receiver element. The spacer beads may be dispersed in an appropriate polymeric binder.

After a dye image is transferred to a first thermal dye receiving element, the dye image may be transferred to a second thermal dye receiving element. This can be accomplished, for example, but passing the two receiving elements between a pair of heated rollers. Other methods of transferring the dye image can also be used including the use of a heated platen, pressure and heat, or external heating.

In making a color proof, a set of electrical signals can be generated that is representative of the shape and color of the original image. This can be done, for example, by scanning an original image, filtering the image to separate it into the desired additive primary colors (red, blue, and green), and then converting the light energy into electrical energy. The electrical signals are then modified by computer to form the color separation data that are used to form a halftone color proof. Instead of scanning an original object to obtain the electrical signals, the signals may be generated by computer.

Either or both of the thermal donor element and thermal dye receiving element in the thermal dye transfer assemblage of this invention can contain the spirobiindane described herein according to this invention.

This assembly may be preassembled as an integral unit when a monochrome image is to be obtained. This may be done by temporarily adhering the two elements together at their margins. After dye transfer has occurred, the two elements are then peeled apart.

When a three or more color image is to be obtained, the assemblage is formed three or more times using different thermal dye donor elements. After the first dye is transferred, the elements are peeled apart, and a second thermal dye donor element (or another area of the thermal donor element with a different dye area) is then brought into register with the thermal dye receiving element and the process is repeated. The third and any additional colors are obtained in the same manner.

The following Examples are provided to illustrate the practice of this invention and not to be limiting in any manner.

### EXAMPLE 1

### Thermal Dye Receiving Element

The spirobiindane used in this example was 3,3,3′,3′-tetramethyl-5,5′6,6′-tetrapropoxy-1,1′-spirobiindane that has the following structure:

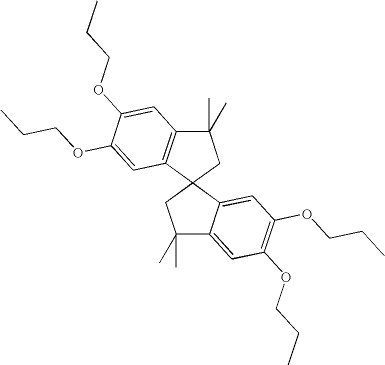

A pre-mix solution was prepared from the following components:

13.22 g of Butvar® B-76 poly(vinyl butyral)

0.28 g of 19 μm crosslinked polystyrene beads

59.5 g of isopropyl alcohol (IPA)

2 g of 1-methoxypropan-2-ol (or Dowanol® PM) (PGME)

25 g of methyl ethyl ketone (MEK).

A sample (25 g) of this pre-mix solution was mixed with 0.10 g of the noted spirobiindane to form a coating formulation. The topcoat beaded dye transfer layer was removed by heated lamination from samples of commercially available Approval® Intermediate sheets. The coating formulation was then applied using a #50 Meyer bar to provide 850 mg/ft² (9.18 g/m²) coatings on the remaining cushion layer of the sheets (at 3 dry weight % of the spirobiindane). The pre-mix was applied without the spirobiindane to other samples of the sheets (Control elements).

The constructed thermal dye receiving elements (both Invention and Control) were imaged using thermal dye donor elements prepared as described for the Control elements in Invention Example 3 below and a laboratory imager similar to the commercial Approval® imager, and the images were then transferred to sheets of commercially available Lustro Gloss paper (80#, available from S.D. Warren Co., Boston, Mass.). The various thermal dye receiving elements were imaged at imaging densities varying from about 0.3 to about 1.9.

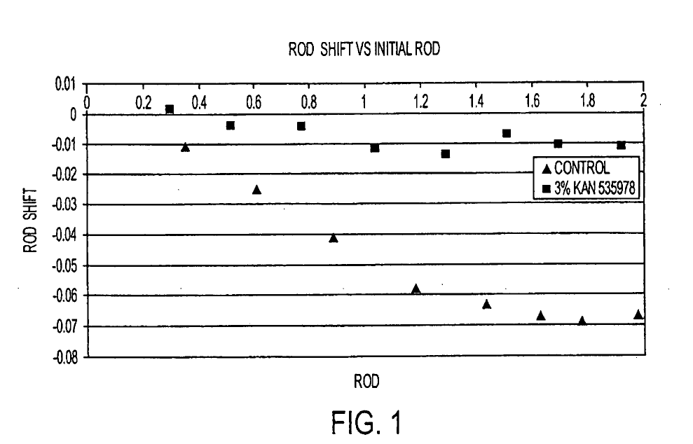

The density of the resulting images in the commercial papers was measured after imaging and then 3 days later after exposure to 5.8 klux at room temperature. The change (shift) in optical density at each imaging density was then evaluated after the 3-day exposure and the results are shown in FIG. 1 (Invention data are shown as squares and the Control data are shown as triangles). It is clear that the presence of the spirobiindane at 3 weight % significantly improved the stability of the resulting images to light exposure since the shift in optical density was much less with the Invention elements at all tested imaging densities.

### EXAMPLE 2

### Thermal Dye Receiving Elements

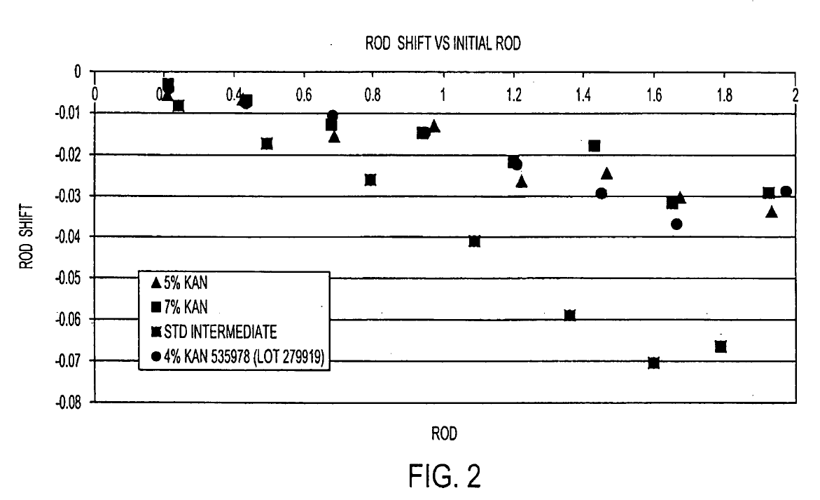

Both Control and Inventive thermal dye receiving elements were prepared and tested as described in Example 1 except the Inventive elements contained varying amounts of the spirobiindane (4, 5, and 7 weight %). FIG. 2 shows the results wherein the Invention data are shown as circles (4 weight %), triangles (5 weight %), and upper level squares (7 weight %) while the Control data (no spirobiindane) element are shown as lower level squares.

### Example 3

### Thermal Dye Donor

A magenta thermal dye donor solution was prepared by coating the following components on a poly(ethylene terephthalate) substrate:

60.32 g of Elvacite® (7% solution in toluene/PGME)

1.28 g of HAG-D94 dye

0.24 g of Solvent Yellow 93 dye

1.99 g of MY2500 FYJ dye

0.87 g of MM500 FEU dye

0.39 g of 545636 IR dye

20.95 g of toluene

13.96 g of PGME.

HAG-D94 dye has the following structure:

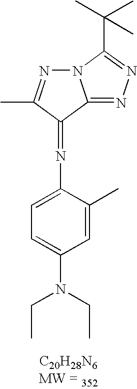

MY2500 FYJ dye has the following structure:

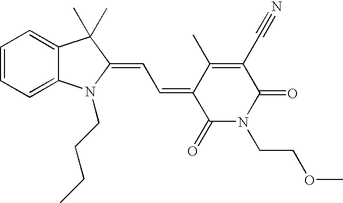

MM2500 FEU dye has the following structure:

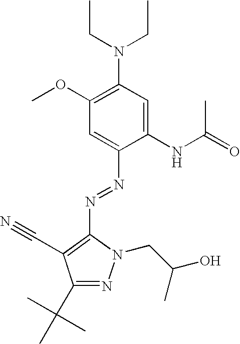

545636 IR dye has the following structure:

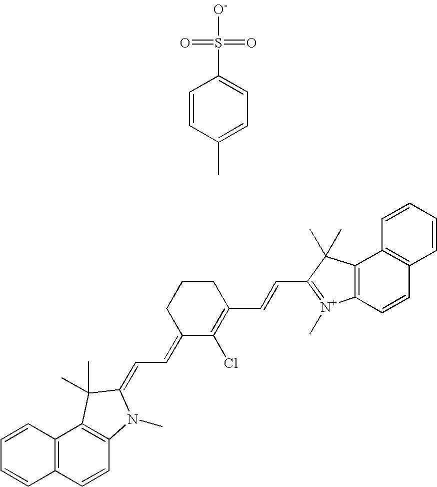

For same of the Invention thermal dye donors, 25 g of the above magenta thermal dye donor solution was mixed with 0.11 g of the spirobiindane described in Example 1 (5 weight %).

For other Invention thermal dye donors, 25 g of the above magenta thermal donor dye solution was mixed with 0.28 g of the spirobiindane (12.5 weight %).

Control thermal dye donors were also prepared but contained no spirobiindane.

The thermal dye donor layers were prepared using a #7 Meyer bar to give approximately 80 mg/ft² (864 mg/m²) dry coverage. The thermal dye donors were then used to image commercially available Approval® Intermediate sheets and the images were then transferred to Lustro Gloss sheets as described in Example 1.

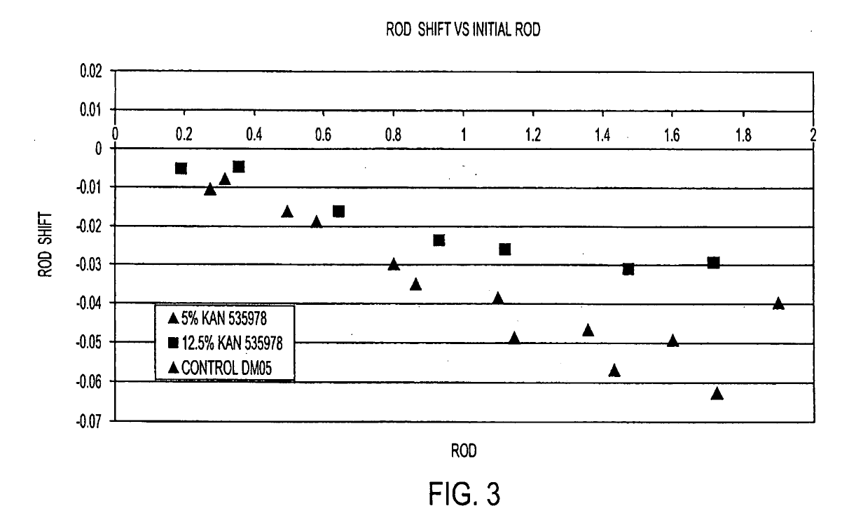

The optical density shift was then evaluated as described in Example 1. The results are shown in FIG. 3 in which the Invention thermal dye donor data (5 dry weight %) are shown as higher level triangles, the Invention thermal dye donor data (12.5 dry weight %) are shown as squares, and the Control thermal dye donor data are shown as lower level triangles.

These data show that the Invention thermal dye donors provided more light stability.

### EXAMPLE 4

### Thermal Dye Receiving Element Imaged with 2 Colors

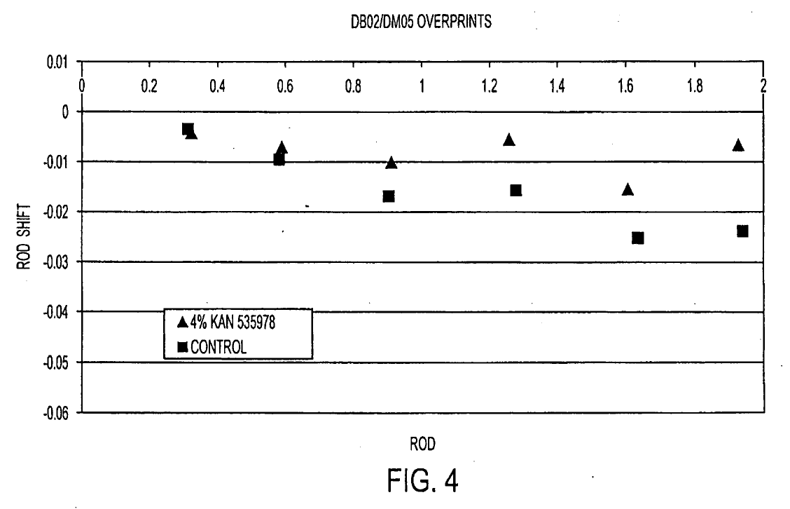

A thermal dye receiving element of this invention was prepared as described in Example 1 containing the spirobiindane at 4% of solids. Samples were imaged using two different thermal dye donors in sequence: first with a commercially available Approval® Donor DB02 and then with the thermal donor prepared as described in Example 3. The resulting two-color images were then transferred to Lustro Glossy sheets and evaluated for optical density shift as described in Example 1. A Control thermal dye receiving element was similarly prepared, imaged, and evaluated without a spirobiindane. The results are shown in FIG. 4 in which the Invention data are shown as triangles and the Control data are shown as squares.

These results show the improved light fade results observed with the practice of the present invention.

### EXAMPLE 5

### Use of Clear Thermal Donor

A “clear” thermal donor was prepared having the coating formulation described below on poly(ethylene terephthalate) substrate. The clear donor contained the spirobiindane additive and no thermally transferable color dyes.

15.08 g of Elvacite® solution (7%)

1.10 g of spirobiindane

0.10 g of 545636 IR dye

5.24 g of toluene

3.50 g of PGME.

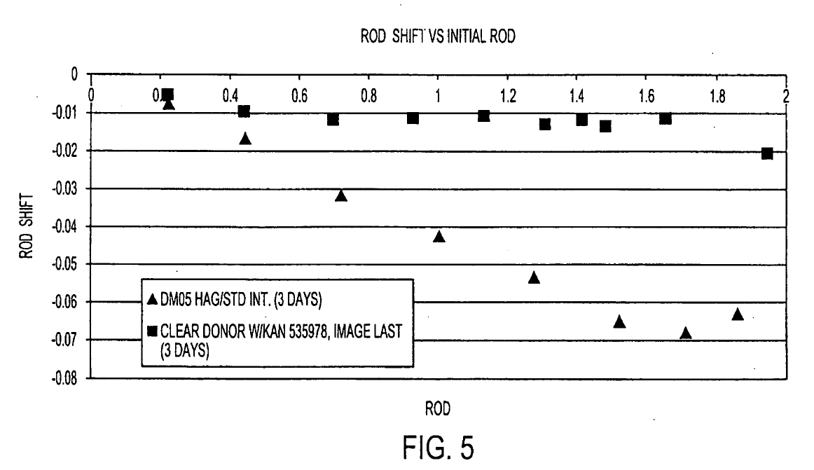

Samples of commercial Approval® Intermediate sheets were imaged first with the magenta thermal dye donor described in Example 1, and then imaged with the “clear” thermal donor as an overprint. The images were then transferred to sheets of Lustro Glossy and evaluated for optical density shift as described in Example 1. Control images were obtained using only the magenta thermal dye donor. The results are shown in FIG. 5 wherein the Control data are illustrated as triangles and the Invention data are illustrated as squares. These results show a dramatic improvement in light stability using the present invention. For example, at 1.65 imaging density the optical density shift was only 0.01 using the Invention but it was 0.07 using the Control thermal dye donor.

### EXAMPLE 6

### Thermal Dye Receiving Element

The spirobiindane used in Example 1 was used at various concentrations in the dye receiving layers of thermal dye receiving elements of this invention. The coating formulations for the dye receiving layers are shown below. Dye images were transferred to the thermal dye receiving elements using the thermal donor elements that are commercially available as Approval® DC02 (cyan) Donors. The images were then transferred as described below and tested for light stability similar to the procedure described in Example 1 at 5.4 Klux Daylight but for 48 hours, 1 week, and 2 weeks time against both external and internal product controls.

The thermal dye receiving elements comprised a polyester compliant release layer coated on an aluminum-containing substrate. The dye receiving layer coating formulation contained:

8.96 g/m² of Butvar® B-76 poly(vinyl butyral),

194 mg/m² of poly(styrene-co-o,m,p-divinylbenzene) (95:5) 19 μm beads,

5.94 mg/m² of DC1248 surfactant (Dow Chemical Co.),

0, 1.62, 2.16, and 2.70 g/m² of spirobiindane, and MEK.

Images were transferred to the thermal dye receiving elements using an APPROVAL® printer that had been modified to handle 10 inch (25.4 cm) wide elements. The images were then transferred by lamination onto paper sheets that had been first prelaminated with the P02 Prelaminate. All readings were made using a Gretag Spectrolino.

The results are shown in the following Tables using two different types of papers for the final transferred image:

### Donor DC02 Printed at Nominally 1.35 Status T Reflection Density and Laminated to Heller & Usdan Paper Sheets

| Sample ID | | 48 hrs | 1 week | 2 weeks |
|---|---|---|---|---|
| External Control (no | Density loss | −0.06 | −0.13 | −0.21 |
| spirobiindane) | Delta E | 2.1 | 5.0 | 8.2 |
| Internal Control (no | Density loss | −0.04 | −0.16 | −0.20 |
| spirobiindane) | Delta E | 1.9 | 5.7 | 7.4 |
| Spirobiindane at 1.62 g/m² | Density loss | −0.03 | −0.05 | −0.08 |
| | Delta E | 1.0 | 2.1 | 3.5 |
| Spirobiindane at 2.16 g/m² | Density loss | −0.02 | −0.04 | −0.06 |
| | Delta E | 0.7 | 1.7 | 2.8 |
| Spirobiindane at 2.70 g/m² | Density loss | −0.02 | −0.04 | −0.06 |
| | Delta E | 0.8 | 1.9 | 2.9 |

These results show a significant improvement in the light fastness with the use of the spirobiindane.

The invention has been described in detail with particular reference to certain preferred embodiments thereof, but it will be understood that variations and modifications can be effected within the spirit and scope of the invention.

1. A thermal element comprising a support and having disposed thereon either a thermal donor layer or a thermal dye receiving layer, said thermal dye element further comprising a spirobiindane in an amount of at least 20 mg/m².

2. The element of claim 1 wherein said spirobiindane can be represented by the following Structure (SP): 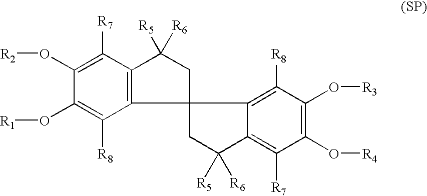
wherein R₁ through R₄ are independently substituted or unsubstituted alkyl substituted or unsubstituted cycloalkyl, substituted or unsubstituted aryl, substituted or unsubstituted heterocyclyl, halo, —COOR₈, or —CONR₉R₁₀ groups, and R₅ through R₈ are independently substituted or unsubstituted hydrogen or alkyl, cycloalkyl, aryl, or halo groups, R₈ is a substituted or unsubstituted alkyl group, and R₉ and R₁₀ are independently hydrogen or a substituted or unsubstituted alkyl group.

3. The element of claim 2 wherein R₁ through R₈ are independently substituted or unsubstituted alkyl groups.

4. The element of claim 2 wherein R₁ through R₄ are the same substituted or unsubstituted alkyl groups and R₅ through R₈ are the same substituted or unsubstituted alkyl groups that are different from those of R₁ through R₄.

5. The element of claim 1 wherein said spirobiindane is 3,3,3′,3′-tetramethyl-5,5′,6,6′-tetrapropoxy-1,1′-spirobiindane, 3,3,3′3′-tetramethyl-5,5′,6,6′-tetraethoxy-1,1′-spirobiindane, or 3,3,3′,3′-tetramethyl-5,5′6,6′-tetrabutoxy-1,1′-spirobiindane.

6. The element of claim 1 wherein said spirobiindane is present in an amount of from about 50 to about 500 mg/m².

7. The element of claim 1 that is a thermal donor and wherein said spirobiindane is dispersed in a polymeric binder in a thermal donor layer.

8. The element of claim 7 wherein said polymeric binder is a cellulosic material, polycarbonate, poly(vinyl acetate), copolymer of styrene and acrylonitrile, a (meth)acrylate polymer, a polysulfone, or poly(phenylene oxide).

9. The element of claim 7 wherein said thermal donor is a thermal dye donor and said thermal donor layer is a thermal dye donor layer that comprises one or more cyan, yellow, magenta, or black dyes.

10. The element of claim 1 that is a thermal dye receiving element and wherein said spirobiindane is dispersed in a polymeric binder in a thermal dye receiving layer.

11. The element of claim 10 wherein said polymeric binder is a poly(vinyl acetal), poly(vinyl butyral), or poly(vinyl alcohol-co-vinyl acetal).

12. The element of claim 10 wherein said thermal dye receiving layer further comprises spacer beads.

13. A method of making color proof of a color printed image comprising:
A) generating digital signals representative of at least a portion of a color printed image,
B) contacting a thermal donor element comprising a support having thereon a thermal donor layer with a first thermal dye receiving element comprising a support having thereon a thermal dye receiving layer,
C) using said digital signals to transfer a dye image representative of said portion of said color printed image, from said thermal donor element to said first thermal dye receiving element, and
D) transferring said dye image from said first thermal dye receiving element to a second thermal dye receiving element,
wherein either said thermal donor or said first thermal dye receiving element, or both, comprises a spirobiindane in an amount of at least 20 mg/m².

14. The method of claim 13 wherein said spirobiindane is present in said thermal dye receiving layer that further comprises spacer beads and a polymeric binder.

15. A thermal dye transfer assemblage comprising:
a) a thermal donor element, and
b) a thermal dye receiving element, the thermal dye receiving element being in superposed relationship with the thermal donor element so that the donor layer of the thermal donor element is in contact with the thermal dye image receiving layer of the thermal dye receiving element,
wherein said thermal donor element or said thermal dye receiving element, or both, comprises a spirobiindane in an amount of at least 20 mg/m².
